(19) United States
(12) Patent Application Publication
(10) Pub. No.: US 2026/0031024 A1
(43) Pub. Date: Jan. 29, 2026

(54) DISPLAY DEVICE AND ELECTRONIC DEVICE INCLUDING THE SAME

(71) Applicant: Samsung Display Co., Ltd., Yongin-Si (KR)

(72) Inventors: JAEKEUN LIM, Yongin-si (KR); BON-SEOG GU, Yongin-si (KR); JINYOUNG ROH, Yongin-si (KR); JIN-WOOK YANG, Yongin-si (KR)

(21) Appl. No.: 19/232,075

(22) Filed: Jun. 9, 2025

(30) Foreign Application Priority Data
Jul. 29, 2024 (KR) 10-2024-0099968

(51) Int. Cl. G09G 3/32

(52) U.S. Cl. CPC G09G 3/32; G09G 2300/0819; G09G 2310/0267; G09G 2310/0275; G09G 2310/08; G09G 2330/021

(57) ABSTRACT

Disclosed is a display device that includes a first scan line, a second scan line, a data line, a first pixel electrically connected to the first scan line and the data line, and a second pixel electrically connected to the first scan line, the second scan line, and the data line. The first pixel includes a first driving transistor connected to a first light emitting element and a first switching transistor connected between a gate of the first driving transistor and the data line. The second pixel includes a second driving transistor connected to a second light emitting element and a second switching transistor connected between a gate of the second driving transistor and the data line. One of the first switching transistor and the second switching transistor is an N-type transistor, and the other one thereof is a P-type transistor.

### CROSS-REFERENCE TO RELATED APPLICATIONS

This application claims priority under 35 U.S.C. § 119 to Korean Patent Application No. 10-2024-0099968 filed on Jul. 29, 2024, in the Korean Intellectual Property Office, the disclosure of which is incorporated by reference herein in its entirety.

### BACKGROUND

Embodiments of the present disclosure described herein relate to a display device and an electronic device including the same having reduced power consumption and improved display quality.

Multimedia electronic devices such as televisions (TVs), mobile phones, tablet computers, navigation systems, and game consoles include a display device for displaying an image. The display device includes a display panel and a driver. The driver includes a scan driver that provides a scan signal to a plurality of scan lines and a data driver that provides a data voltage to data lines.

### SUMMARY

Embodiments of the present disclosure provide a display device and an electronic device including the same having reduced power consumption and improved display quality.

According to an embodiment, a display device includes a first scan line that receives a first scan signal, a second scan line that receives a second scan signal, a data line that receives a first data voltage and a second data voltage, a first pixel electrically connected to the first scan line and the data line, and a second pixel electrically connected to the first scan line, the second scan line, and the data line, wherein the first pixel includes a first light emitting element, a first driving transistor connected to the first light emitting element, and a first switching transistor connected between a gate of the first driving transistor and the data line, the second pixel includes a second light emitting element, a second driving transistor connected to the second light emitting element, and a second switching transistor connected between a gate of the second driving transistor and the data line, and one of the first switching transistor and the second switching transistor is an N-type transistor, and the other one thereof is a P-type transistor.

According to an embodiment, a gate of the first switching transistor may be connected to the first scan line, and an operation of the first switching transistor may be controlled by the first scan signal, and a gate of the second switching transistor may be connected to the second scan line, and an operation of the second switching transistor may be controlled by the second scan signal.

According to an embodiment, the second pixel may further include a third switching transistor connected between the gate of the second driving transistor and the second switching transistor, and a gate of the third switching transistor may be connected to the first scan line, and an operation of the third switching transistor may be controlled by the first scan signal.

According to an embodiment, the first switching transistor may be an N-type transistor, the second switching transistor may be a P-type transistor, and the third switching transistor may be an N-type transistor.

According to an embodiment, the first pixel may further include a fourth switching transistor connected between the data line and the first switching transistor, and a gate of the fourth switching transistor may be connected to the second scan line, and an operation of the fourth switching transistor may be controlled by the second scan signal.

According to an embodiment, the second pixel may further include a third switching transistor connected between the second switching transistor and the data line, and a gate of the third switching transistor may be connected to the first scan line, and an operation of the third switching transistor may be controlled by the first scan signal.

According to an embodiment, the first switching transistor may be electrically connected to a connection node between the second switching transistor and the third switching transistor, and the first switching transistor may be electrically connected to the data line through the third switching transistor.

According to an embodiment, the first pixel may further include a fourth switching transistor connected between the first switching transistor and a first node, and a gate of the fourth switching transistor may be connected to the second scan line, and an operation of the fourth switching transistor may be controlled by the second scan signal.

According to an embodiment, the first pixel may further include a first initialization transistor connected to the first light emitting element, and the second pixel may further include a second initialization transistor connected to the second light emitting element, and gates of the first initialization transistor and the second initialization transistor may be connected to the first scan line, and operations of the first initialization transistor and the second initialization transistor may be controlled by the first scan signal.

According to an embodiment, the first driving transistor, the second driving transistor, the first initialization transistor, and the second initialization transistor may be N-type transistors.

According to an embodiment, the first driving transistor and the second driving transistor may be P-type transistors, and the first initialization transistor and the second initialization transistor may be N-type transistors.

According to an embodiment, the first driving transistor, the second driving transistor, the first initialization transistor, and the second initialization transistor may be P-type transistors.

According to an embodiment, a first part of the first scan signal in a first level section may overlap a second part of the second scan signal in a second level section.

According to an embodiment, a length of each of the first level section and the second level section may be greater than or equal to 1.5 horizontal periods and less than 2 horizontal periods, and a length of each of the first part and the second part may be greater than or equal to 0.5 horizontal periods and less than 1 horizontal period.

According to an embodiment, an electronic device includes a display device for displaying an image, the display device includes a first pixel including a first driving transistor and a first switching transistor, a second pixel including a second driving transistor and a second switching transistor, a first scan line that receives a first scan signal, a second scan line that receives a second scan signal, and a data line electrically connected to the first pixel and the second pixel, wherein a gate of the first switching transistor is connected to the first scan line, and an operation of the first switching transistor is controlled by the first scan signal, a gate of the second switching transistor is connected to the second scan line, and an operation of the second switching transistor is controlled by the second scan signal, and one of the first switching transistor and the second switching transistor is an N-type transistor, and the other one thereof is a P-type transistor.

According to an embodiment, the second pixel may further include a third switching transistor connected between a gate of the second driving transistor and the second switching transistor, and a gate of the third switching transistor may be connected to the first scan line, and an operation of the third switching transistor may be controlled by the first scan signal.

According to an embodiment, the first pixel may further include a fourth switching transistor connected between the data line and the first switching transistor, and a gate of the fourth switching transistor may be connected to the second scan line, and an operation of the fourth switching transistor may be controlled by the second scan signal.

According to an embodiment, the second pixel may further include a third switching transistor connected between the second switching transistor and the data line, and a gate of the third switching transistor may be connected to the first scan line, and an operation of the third switching transistor may be controlled by the first scan signal.

According to an embodiment, the first switching transistor may be electrically connected to a connection node between the second switching transistor and the third switching transistor, and the first switching transistor may be electrically connected to the data line through the third switching transistor.

According to an embodiment, a first part of the first scan signal in a first level section may overlap a second part of the second scan signal in a second level section.

### BRIEF DESCRIPTION OF THE FIGURES

The above and other objects and features of the present disclosure will become apparent by describing in detail embodiments thereof with reference to the accompanying drawings.

FIG. 1 is a block diagram of a display device according to an embodiment of the present disclosure.

FIG. 2 is a plan view of the display device according to an embodiment of the present disclosure.

FIG. 3 is an equivalent circuit diagram of a first pixel and a second pixel according to an embodiment of the present disclosure.

FIG. 4 is a timing diagram for describing operations of the first pixel and the second pixel according to an embodiment of the present disclosure.

FIG. 5A is a view for describing the operations of the first pixel and the second pixel in a first section of FIG. 4 according to an embodiment of the present disclosure.

FIG. 5B is a view for describing the operations of the first pixel and the second pixel in a second section of FIG. 4 according to an embodiment of the present disclosure.

FIG. 5C is a view for describing the operations of the first pixel and the second pixel in a third section of FIG. 4 according to an embodiment of the present disclosure.

FIG. 6A is an equivalent circuit diagram of the first pixel and the second pixel according to an embodiment of the present disclosure.

FIG. 6B is an equivalent circuit diagram of the first pixel and the second pixel according to an embodiment of the present disclosure.

FIG. 7A is an equivalent circuit diagram of the first pixel and the second pixel according to an embodiment of the present disclosure.

FIG. 7B is an equivalent circuit diagram of the first pixel and the second pixel according to an embodiment of the present disclosure.

FIG. 8A is an equivalent circuit diagram of the first pixel and the second pixel according to an embodiment of the present disclosure.

FIG. 8B is an equivalent circuit diagram of the first pixel and the second pixel according to an embodiment of the present disclosure.

FIG. 9A is a timing diagram for describing the operations of the first pixel and the second pixel according to an embodiment of the present disclosure.

FIG. 9B is an equivalent circuit diagram of the first pixel and the second pixel according to an embodiment of the present disclosure.

FIG. 9C is an equivalent circuit diagram of the first pixel and the second pixel according to an embodiment of the present disclosure.

### DETAILED DESCRIPTION

In the specification, the expression that a first component (or area, layer, part, portion, etc.) is “disposed on”, “connected with” or “coupled to” a second component means that the first component is directly disposed on/connected with/coupled to the second component or means that a third component is interposed therebetween.

The same reference numerals refer to the same components. Further, in the drawings, the thickness, the ratio, and the dimension of components are exaggerated for effective description of technical contents.

Although the terms “first”, “second”, etc. may be used to describe various components, the components should not be limited by the terms. The terms are only used to distinguish one component from another component. For example, without departing from the right scope of the present disclosure, a first component may be referred to as a second component, and similarly, the second component may be also referred to as the first component. Singular expressions include plural expressions unless clearly otherwise indicated in the context.

Also, the terms “under”, “below”, “on”, “above”, etc. are used to describe the correlation of components illustrated in drawings. The terms that are relative in concept are described based on a direction illustrated in drawings.

It will be understood that the terms “include”, “comprise”, “have”, etc. specify the presence of features, numbers, steps, operations, elements, or components, described in the specification, or a combination thereof, and do not exclude in advance the presence or additional possibility of one or more other features, numbers, steps, operations, elements, or components or a combination thereof.

Unless otherwise defined, all terms (including technical terms and scientific terms) used in the specification have the same meaning as commonly understood by those skilled in the art to which the present disclosure belongs. Further, terms such as terms defined in the dictionaries commonly used should be interpreted as having a meaning consistent with the meaning in the context of the related technology and should not be interpreted in overly ideal or overly formal meanings unless explicitly defined herein.

Terms “part” and “unit” may mean a software component or a hardware component that performs a specific function. The hardware component may include, for example, a field-programmable gate array (FPGA) or an application-specific integrated circuit (ASIC). The software component may refer to executable code, or data used by the executable code in an addressable storage medium. Thus, the software components may be, for example, object-oriented software components, class components, and task components, and may include processes, functions, attributes, procedures, subroutines, program code segments, drivers, firmwares, microcodes, circuits, data, database, data structures, tables, arrays, or variables.

Hereinafter, an embodiment of the present disclosure will be described with reference to the accompanying drawings.

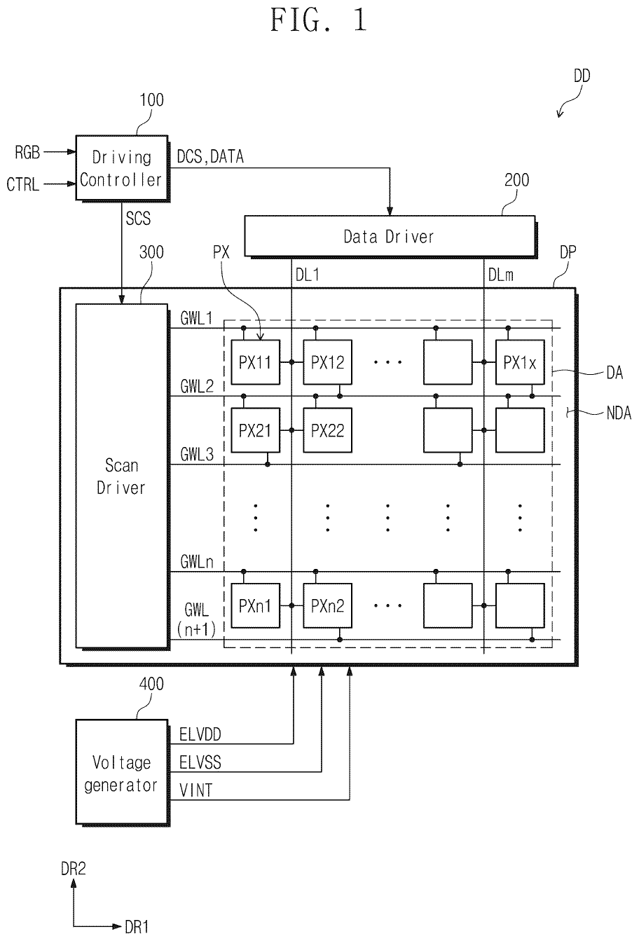

FIG. 1 is a block diagram of a display device DD according to an embodiment of the present disclosure.

Referring to FIG. 1, the display device DD includes a display panel DP, a driving controller 100, a data driver 200, a scan driver 300, and a voltage generator 400.

The driving controller 100 receives an input image signal RGB and a control signal CTRL. The driving controller 100 generates an output image signal DATA obtained by converting a data format of the input image signal RGB such that the output image signal DATA matches an interface specification with the data driver 200. The driving controller 100 outputs a scan driving signal SCS and a data driving signal DCS.

The data driver 200 receives the data driving signal DCS and the output image signal DATA from the driving controller 100. The data driver 200 converts the output image signal DATA into data signals and outputs the data signals to a plurality of data lines DL1 to DLm, which will be described below. The data signals are analog voltages corresponding to a grayscale value of the output image signal DATA.

The voltage generator 400 generates voltages required for operating the display panel DP. In an embodiment, the voltage generator 400 generates a first driving voltage ELVDD, a second driving voltage ELVSS, and an initialization voltage VINT.

The display panel DP includes scan lines GWL1 to GWL(n+1), the data lines DL1 to DLm, and pixels PX.

The pixels PX may be arranged in a display area DA, and the scan driver 300 may be disposed in a non-display area NDA. However, the present disclosure is not limited thereto, and at least some of the pixels PX may overlap the scan driver 300. In this case, at least a portion of the scan driver 300 may be disposed in the display area DA.

The scan driver 300 receives the scan driving signal SCS from the driving controller 100. The scan driver 300 may output scan signals to the scan lines GWL1 to GWL(n+1) in response to the scan driving signal SCS.

The scan driver 300 is disposed on a first side of the display panel DP. The scan lines GWL1 to GWL(n+1) extend from the scan driver 300 in a first direction DR1 and are arranged to be spaced apart from each other in a second direction DR2. The data lines DL1 to DLm extend from the data driver 200 in a direction opposite to the second direction DR2 and are arranged to be spaced apart from each other in the first direction DR1.

According to an embodiment of the present disclosure, pixels PX11 and PX12 adjacent to each other in the first direction DR1, which is a horizontal line, among the plurality of pixels PX, may share the data line DL1. Thus, the pixels PX11 and PX12 among the pixels PX11 to PX1x arranged on the horizontal line may be electrically connected to the data line DL1. For example, as illustrated in FIG. 1, each of the pixels PX11 and PX12 arranged on a first column and a second column among the pixels PX11 to PX1x in a first row may be electrically connected to the first data line DL1. Further, each of pixels PX21 and PX22 arranged in the first column and the second column among the pixels PX21 to PX2x in a second row may be electrically connected to the first data line DL1.

The number of pixels PX11 to PX1x arranged on the horizontal line inside the display panel DP may be “x”, and the number of data lines DL1 to DLm may be m. In this case, “m”, which is the number of data lines DL1 to DLm, may be a half of “x”, which is the number of pixels PX11 to PX1x arranged in the horizontal line. As the number of data lines DL1 to DLm decreases, power consumption due to output of data voltages to the data lines DL1 to DLm may decrease. Further, as the number of output terminals of the data driver 200 decreases, manufacturing costs of the data driver 200 may decrease.

In an embodiment of the present disclosure, each of the plurality of pixels PX may be connected to the scan line GWL1 or the scan lines GWL1 and GWL2. For example, the pixel PX11 disposed in the first row and the first column may be connected to the first scan line GWL1, and the other pixel PX12 disposed in the first row and the second column may be connected to the first scan line GWL1 and the second scan line GWL2. According to a structure of a pixel circuit included in each of the pixels PX, the scan line GWL1 may be connected to the pixel or the scan lines GWL1 and GWL2 may be connected to the pixel, and a detailed description thereof will be made below.

In an embodiment of the present disclosure, at least some of the pixels PX adjacent to each other in the second direction DR2 that is a vertical direction may be arranged to share the scan line GWL2. Thus, the pixels PX12 and PX22 among the pixels PX12 to PXn2 arranged on a vertical line may be electrically connected to the scan line GWL2. For example, the pixels PX11 and PX21 in the first row and the second row among the pixels PX11 to PXn1 in the first column in FIG. 1 may not share the same scan line GWL2, and the pixels PX12 and PX22 in the first row and the second row among the pixels PX12 to PXn2 in the second column may share the second scan line GWL2 and may be electrically connected to the same scan line GWL2.

According to an embodiment of the present disclosure, at least some of the pixels PX11 to PX1x arranged in a row may be connected to the scan lines GWL1 and GWL2. In this case, a signal transmitted through the data line DL1 may be transmitted to one of the pixels PX11 and PX12 connected to the data line DL1 and arranged in the same row. That is, an additional circuit for transmitting the signal to one of the pixels PX11 and PX12 may be omitted, and thus a signal for controlling the additional circuit may not be required. That is, as the additional circuit is omitted, power consumption of the display device DD may be reduced.

Each of the plurality of pixels PX includes a light emitting element and a pixel circuit that controls light emission of the light emitting element. The pixel circuit may include one or more thin film transistors and one or more capacitors. The scan driver 300 may include thin film transistors formed through the same process as the pixel circuit.

Each of the plurality of pixels PX receives the first driving voltage ELVDD, the second driving voltage ELVSS, and the initialization voltage VINT from the voltage generator 400.

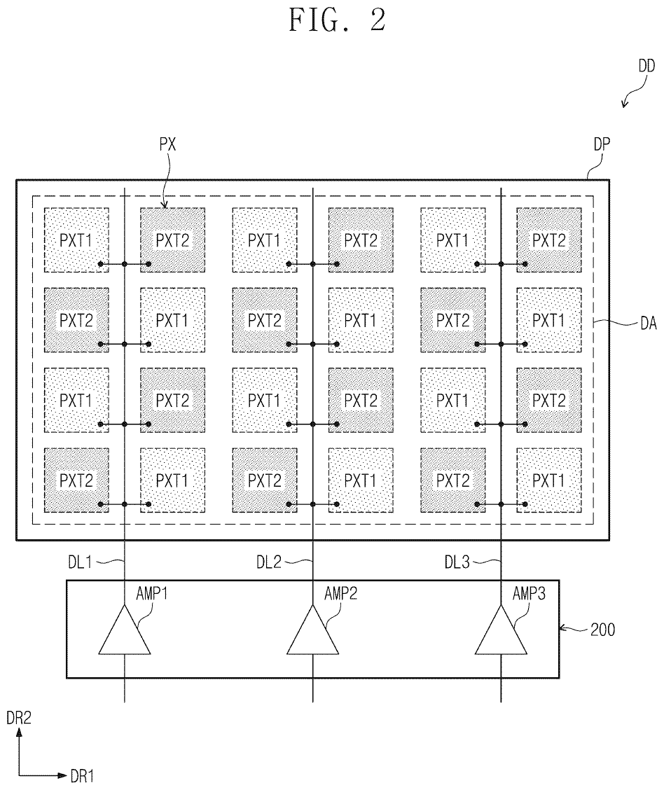

FIG. 2 is a plan view of the display device DD according to an embodiment of the present disclosure.

Referring to FIGS. 1 and 2, the display device DD may further include a plurality of amplifiers AMP1, AMP2, and AMP3 that transmit signals to the display panel DP. For example, the plurality of amplifiers AMP1, AMP2, and AMP3 may be included in the data driver 200.

The plurality of pixels PX arranged in the display area DA of the display panel DP may be represented as a first pixel PXT1 or a second pixel PXT2. The first pixel PXT1 may be referred to as a first type pixel, and the second pixel PXT2 may be referred to as a second type pixel. FIG. 2 illustrates the pixels PX corresponding to four rows and six columns.

The first pixel PXT1 and the second pixel PXT2 may be adjacent to each other in the first direction DR1, which is a horizontal direction, and share the data line DL1. The first pixels PXT1 and the second pixels PXT2 may be arranged to intersect each other in the first direction DR1 and may be arranged to intersect each other in a direction opposite to the second direction DR2. For example, the pixels PX11 to PX1x (see FIG. 1) in the first row may be arranged in an order of the first pixel PXT1, the second pixel PXT2, the first pixel PXT1, and the second pixel PXT2 in the first direction DR1, and the pixels PX11 to PXn1 (see FIG. 1) in the first column may be arranged in an order of the first pixel PXT1, the second pixel PXT2, the first pixel PXT1, and the second pixel PXT2 in the direction opposite to the second direction DR2.

A first pixel PXT1 may be surrounded by second pixels PXT2, and a second pixel PXT2 may be surrounded by first pixels PXT1. The first pixels PXT1 and the second pixels PXT2 are arranged to intersect each other, and thus the number of first pixels PXT1 and the number of second pixels PXT2 may be the same. However, the present disclosure is not limited thereto, and the number of first pixels PXT1 and the number of second pixels PXT2 may be different from each other.

According to an embodiment of the present disclosure, even when the display panel DP includes different types of pixels, for example, the first pixels PXT1 and the second pixels PXT2, the first pixels PXT1 and the second pixels PXT2 may intersect each other and may be arranged in the first direction DR1 and the second direction DR2. Thus, even when a difference in luminance occurs between the first pixel PXT1 and the second pixel PXT2 due to a difference of a circuit configuration, the difference in luminance may not be visually recognized. Thus, display quality of the display device DD may be improved.

FIG. 2 illustrates that the first pixel PXT1 and the second pixel PXT2 are repeatedly arranged in the first direction DR1 and the second direction DR2, but the present disclosure is not particularly limited thereto. For example, the first pixel PXT1 and the second pixel PXT2 may be repeatedly arranged in the first direction DR1, and two or more first pixels PXT1 and two or more second pixels PXT2 may be repeatedly arranged in the second direction DR2.

The plurality of amplifiers AMP1, AMP2, and AMP3 may be electrically connected to the data lines DL1, DL2, and DL3 and output data voltages to the data lines DL1, DL2, and DL3. Thus, the number of amplifiers AMP1, AMP2, and AMP3 may be the same as the number of data lines DL1, DL2, and DL3. As described above, as the data line DL1 is electrically connected to the pixels PX11 and PX12 (see FIG. 1), the number of amplifiers AMP1, AMP2, and AMP3 may also be reduced. Thus, power consumption of the display device DD may be reduced.

FIG. 2 illustrates the display device DD including the three amplifiers AMP1, AMP2, and AMP3, the three data lines DL1, DL2, and DL3, and twenty-four pixels PX but the display device is not limited to this and may include more or less amplifiers, data lines, and pixels.

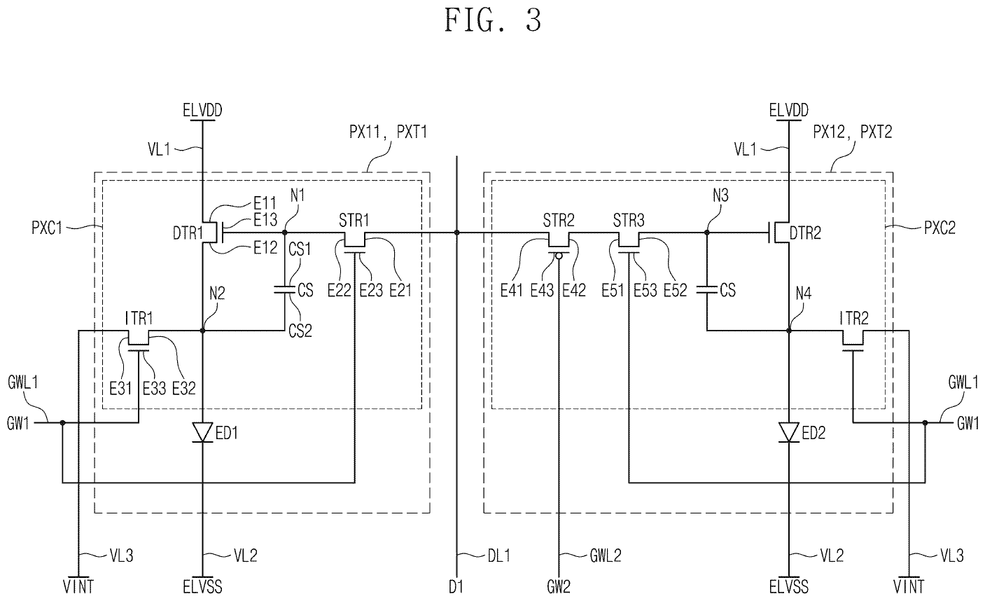

FIG. 3 is an equivalent circuit diagram of the first pixel PXT1 and the second pixel PXT2 according to an embodiment of the present disclosure.

FIG. 3 illustrates an equivalent circuit diagram of the first pixel PXT1 connected to the first data line DL1 among the data lines DL1 to DLm and the first scan line GWL1 among the scan lines GWL1 to GWL(n+1) and the second pixel PXT2 connected to the first and second scan lines GWL1 and GWL2. Referring to FIG. 2 together, it will be described as an example that the first pixel PXT1 is the pixel PX11 disposed in the first row and the first column, and the second pixel PXT2 is the pixel PX12 disposed in the first row and the second column. Hereinafter, the first data line DL1 is referred to as the data line DL1, the first scan line GWL1 is referred to as the first scan line GWL1, and the second scan line GWL2 is referred to as the second scan line GWL2.

The first scan line GWL1 and the second scan line GWL2 receive and transmit a first scan signal GW1 and a second scan signal GW2, and the data line DL1 receives and transmits a data signal D1. The data signal D1 may have a voltage level corresponding to the image signal RGB input to the display device DD (see FIG. 1).

First to third driving voltage lines VL1, VL2, and VL3 may transmit the first driving voltage ELVDD, the second driving voltage ELVSS, and the initialization voltage VINT to the first pixel PXT1 and the second pixel PXT2.

The first pixel PXT1 may include a first pixel circuit PXC1 and a first light emitting element ED1. The first pixel circuit PXC1 may include a first driving transistor DTR1, a first switching transistor STR1, a first initialization transistor ITR1, and a capacitor CS.

The first pixel PXT1 may be electrically connected to the first scan line GWL1 and the data line DL1.

The first driving transistor DTR1 may include a first electrode E11 electrically connected to the first driving voltage line VL1, a second electrode E12 electrically connected to an anode of the first light emitting element ED1, and a gate electrode E13. A portion of the first driving transistor DTR1 in which the second electrode E12 and the first light emitting element ED1 are connected may be defined as a second node N2. The first driving transistor DTR1 may be connected to the first light emitting element ED1.

The first switching transistor STR1 includes a first electrode E21 connected to the data line DL1, a second electrode E22 connected to a first node N1, and a gate electrode E23 connected to the first scan line GWL1. The first switching transistor STR1 may be connected between a gate of the first driving transistor DTR1 and the data line DL1.

A gate of the first switching transistor STR1 may be connected to the first scan line GWL1, and an operation of the first switching transistor STR1 may be controlled by the first scan signal GW1 received through the first scan line GWL1. The first switching transistor STR1 may transmit the data signal D1 received through the data line DL1 to the first node N1 in response to the first scan signal GW1.

The first initialization transistor ITR1 includes a first electrode E31 connected to the third driving voltage line VL3, a second electrode E32 connected to the second node N2, and a gate electrode E33 connected to the scan line GWL1. The first initialization transistor ITR1 may be connected to the first light emitting element ED1, and a gate of the first initialization transistor ITR1 may be connected by the first scan line GWL1.

An operation of the first initialization transistor ITR 1 may be controlled by the first scan signal GW1 received through the first scan line GWL1. The first initialization transistor ITR1 may transmit the initialization voltage VINT received through the third driving voltage line VL3 to the second node N2 in response to the first scan signal GW1.

FIG. 3 illustrates that the first initialization transistor ITR1 and the first switching transistor STR1 are connected to the same first scan line GWL1 and operations thereof are controlled by the first scan signal GW1, but the present disclosure is not limited thereto. For example, the display device DD (see FIG. 1) may further include an initialization scan line to which an initialization scan signal is provided, and the operation of the first initialization transistor ITR1 may be controlled by the initialization scan signal. A waveform of the initialization scan signal may be the same as or different from a waveform of the first scan signal GW1.

The first light emitting element ED1 may include an anode connected to the second electrode E12 of the first driving transistor DTR1 or the second node N2 and a cathode connected to the second driving voltage line VL2.

The capacitor CS may be connected between the first node N1 and the second node N2. A first counter electrode CS1 of the capacitor CS may be connected to the first node N1, and a second counter electrode CS2 of the capacitor CS may be connected to the second node N2. The capacitor CS may store a difference voltage between the first node N1 and the second node N2. The capacitor CS may be referred to as a storage capacitor.

The second pixel PXT2 may include a second pixel circuit PXC2 and a second light emitting element ED2. The second pixel circuit PXC2 may include a second driving transistor DTR2, a second switching transistor STR2, a third switching transistor STR3, a second initialization transistor ITR2, and the capacitor CS.

The second pixel PXT2 may be electrically connected to the first scan line GWL1, the second scan line GWL2, and the data line DL1. For example, the second pixel PXT2 may further include the second switching transistor STR2 as compared to the first pixel PXT1.

Structures of the second driving transistor DTR2 and the second initialization transistor ITR2 of the second pixel PXT2 may be substantially the same as those of the first driving transistor DTR1 and the first initialization transistor ITR1 of the first pixel PXT1. Thus, hereinafter, a detailed description of the structures of the second driving transistor DTR2 and the second initialization transistor ITR2 will be omitted, and a difference will be mainly described.

The structure of the second driving transistor DTR2 may be substantially the same as the structure of the first driving transistor DTR1, and the second driving transistor DTR2 may be electrically connected to the second light emitting element ED2. A portion at which the second driving transistor DTR2 and the second light emitting element ED2 are connected may be defined as a fourth node N4.

The second switching transistor STR2 and the third switching transistor STR3 may be connected between the data line DL1 and a gate of the second driving transistor DTR2.

The second switching transistor STR2 may include a first electrode E41 connected to the data line DL1, a second electrode E42 connected to a first electrode E51 of the third switching transistor STR3, and a gate electrode E43 connected to the second scan line GWL2. The third switching transistor STR3 may include a first electrode E51 connected to the second electrode E42 of the second switching transistor STR2, a second electrode E52 connected to a third node N3, and a gate electrode E53 connected to the first scan line GWL1.

Unlike the first switching transistor STR1, a gate of the second switching transistor STR2 may be connected to the second scan line GWL2, and an operation of the second switching transistor STR2 may be controlled by the second scan signal GW2 received through the second scan line GWL2. The second switching transistor STR2 may transmit the data signal D1 received through the data line DL1 to the third switching transistor STR3 in response to the second scan signal GW2. The third switching transistor STR3 may transmit the data signal D1 transmitted via the second switching transistor STR2 to the third node N3 in response to the first scan signal GW1.

The second initialization transistor ITR2 may be substantially the same as the first initialization transistor ITR1. The second initialization transistor ITR2 may be connected to the second light emitting element ED2, and a gate of the second initialization transistor ITR2 may be connected by the first scan line GWL1. Thus, like the first initialization transistor ITR1, an operation of the second initialization transistor ITR2 may be controlled by the first scan signal GW1 received through the first scan line GWL1. The second initialization transistor ITR2 may transmit the initialization voltage VINT received through the third driving voltage line VL3 to the fourth node N4 in response to the first scan signal GW1. However, the present disclosure is not limited thereto, and the operation of the second initialization transistor ITR2 may be controlled by another scan signal that is not illustrated.

The second light emitting element ED2 may include an anode connected to the second electrode E12 of the second driving transistor DTR2 or the fourth node N4 and a cathode connected to the second driving voltage line VL2. The first light emitting element ED1 and the second light emitting element ED2 may emit lights according to corresponding data voltages.

In an embodiment of the present disclosure, one of the first switching transistor STR1 and the second switching transistor STR2 may be an N-type transistor, and the other one thereof may be a P-type transistor. One of the second switching transistor STR2 and the third switching transistor STR3 may be an N-type transistor, and the other one thereof may be a P-type transistor.

FIG. 3 illustrates that the first switching transistor STR1 is an N-type transistor, the second switching transistor STR2 is a P-type transistor, and the third switching transistor STR3 is an N-type transistor Further, it is illustratively illustrated that the first driving transistor DTR1, the second driving transistor DTR2, the first initialization transistor ITR1, and the second initialization transistor ITR2 are N-type transistors.

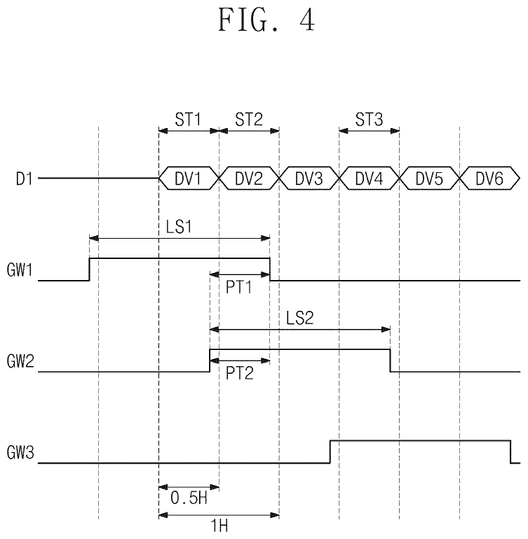

In this case, as illustrated in FIG. 4, a waveform of the first scan signal GW1 of the first scan line GWL1 and a waveform of the second scan signal GW2 of the second scan line GWL2 may be different from each other. Further, the first switching transistor STR1 and the second switching transistor STR2 are different types of transistors. Thus, turn-on timings of the first switching transistor STR1 and the second switching transistor STR2 may be different from each other. Thus, a value of the data signal D1 transmitted to the first node N1 via the first switching transistor STR1 may be different from a value of the data signal D1 transmitted to the third node N3 via the second switching transistor STR2.

The capacitors CS included in the first pixel PXT1 and the second pixel PXT2 may be the same, and the capacitor CS included in the second pixel PXT2 may be connected between the third node N3 and the fourth node N4.

FIG. 3 illustrates that the first pixel circuit PXC1 includes three transistors and one capacitor and that the second pixel circuit PXC2 includes four transistors and one capacitor, but the present disclosure is not limited thereto. For example, each of the first pixel circuit PXC1 and the second pixel circuit PXC2 may further include at least one transistor and at least one capacitor additionally connected in the illustrated structure.

FIG. 4 is a timing diagram for describing operations of the first pixel PXT1 and the second pixel PXT2 according to an embodiment of the present disclosure.

FIG. 4 illustrates output waveforms of the data signal D1 transmitted through the data line DL1, the first scan signal GW1 transmitted through the first scan line GWL1, the second scan signal GW2 transmitted through the second scan line GWL2, and the third scan signal GW3 transmitted through the third scan line GWL3 as described in FIGS. 1 and 3. In this case, the third scan line GWL3 refers to the third scan line GWL3, and the third scan signal GW3 refers to a signal received by the third scan line GWL3.

Referring to FIG. 4, each of a first section ST1, a second section ST2, and a third section ST3 may correspond to a 0.5 horizontal period 0.5 H. That is, a length of one section may be 0.5 horizontal period 0.5 H, and a length of two sections may be 1 horizontal period 1 H.

According to an embodiment of the present disclosure, the data signal D1 may have different data voltages DV1, DV2, DV3, DV4, DV5, and DV6 for each 0.5 horizontal period. For example, the data signal D1 may have the first data voltage DV1 in the first section ST1 and the second data voltage DV2 in the second section ST2.

The first scan signal GW1 received through the first scan line GWL1 may have a first level section LS1 that is a high level section. The second scan signal GW2 received through the second scan line GWL2 may have a second level section LS2 that is a high level section. A length of the first level section LS1 and a length of the second level section LS2 may be greater than or equal to 1.5 horizontal periods and less than 2 horizontal periods.

In an embodiment of the present disclosure, a waveform of the first scan signal GW1 and a waveform of the second scan signal GW2 may be different from each other. In this case, the waveform of the first scan signal GW1 and the waveform of the second scan signal GW2 may overlap each other at a first part PT1 of the first level section LS1 and a second part PT2 of the second level section LS2. A length of the overlapping first part PT1 and a length of the overlapping second part PT2 may be greater than or equal to 0.5 horizontal period and less than 1 horizontal period.

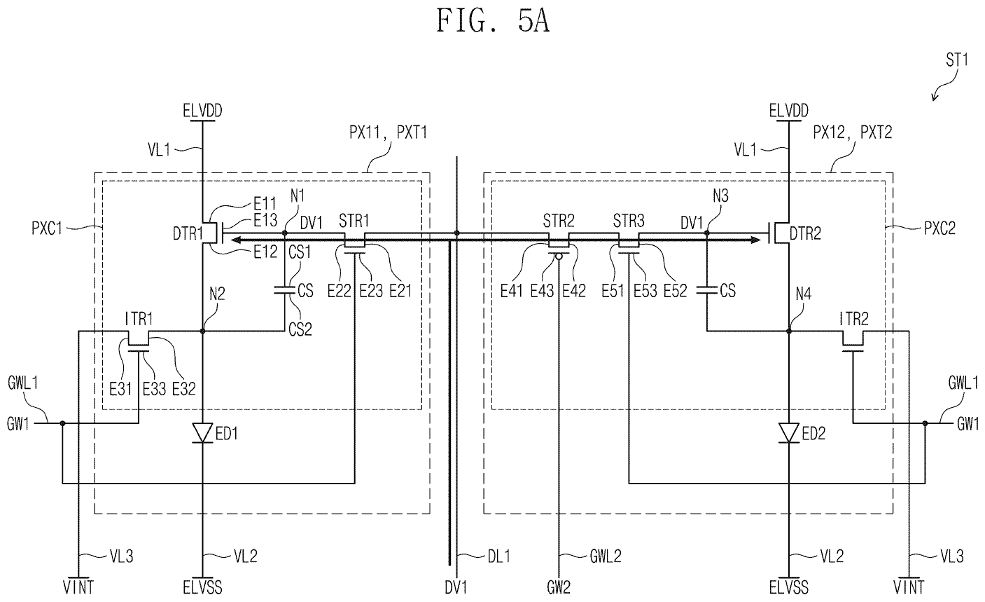

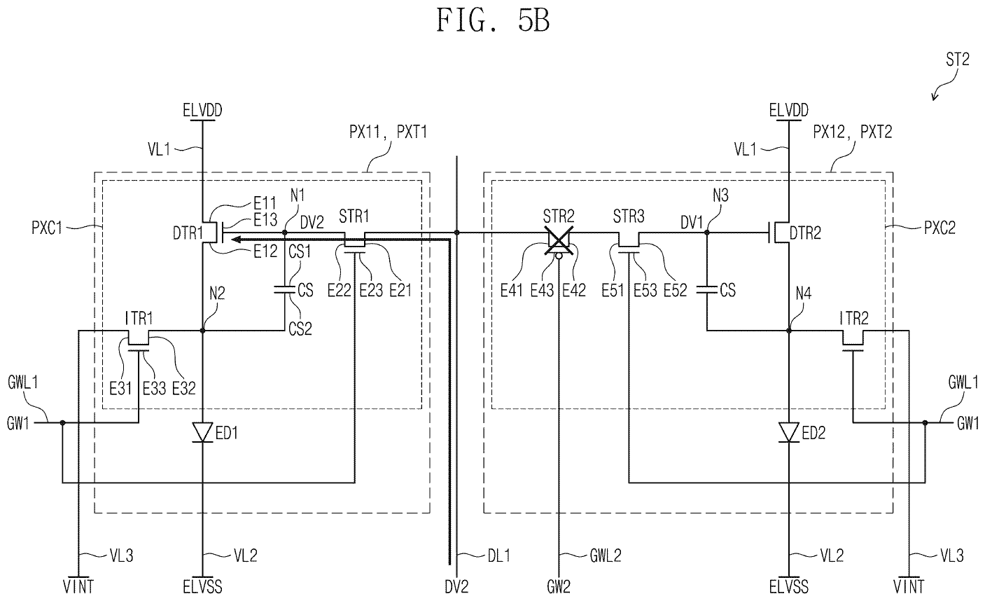

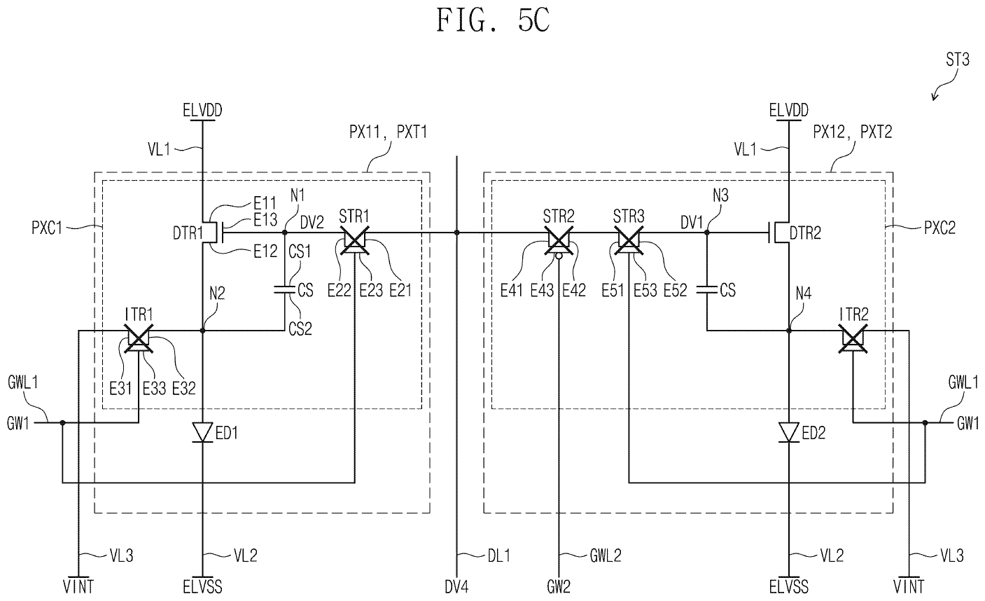

FIG. 5A is a view for describing the operations of the first pixel PXT1 and the second pixel PXT2 in the first section ST1 of FIG. 4 according to an embodiment of the present disclosure. FIG. 5B is a view for describing the operations of the first pixel PXT1 and the second pixel PXT2 in the second section ST2 of FIG. 4 according to an embodiment of the present disclosure. FIG. 5C is a view for describing the operations of the first pixel PXT1 and the second pixel PXT2 in the third section ST3 of FIG. 4 according to an embodiment of the present disclosure.

As illustrated in FIGS. 5A, 5B, and 5C, the first switching transistor STR1 and the third switching transistor STR3 may be N-type transistors, and the second switching transistor STR2 may be a P-type transistor. However, this is merely an example, and another combination may be provided. The N-type transistor may be turned on in the high level section, and the P-type transistor may be turned off in the high level section.

Referring to FIGS. 4 and 5A, the data signal D1 may have the first data voltage DV1 in the first section ST1. The first scan signal GW1 may be in a state of entering the first level section LS1, and the second scan signal GW2 may be in a state of not entering the second level section LS2. That is, in the first section ST1, the first scan signal GW1 may be a high level, and the second scan signal GW2 may be a low level.

Because the operation of the first switching transistor STR1 included in the first pixel PXT1 may be controlled by the first scan signal GW1, the first switching transistor STR1 may be turned on in the first section ST1. As the first switching transistor STR1 is turned on, the first data voltage DV1 received through the data line DL1 may be transmitted to the first node N1 via the first switching transistor STR1.

Because the operation of the second switching transistor STR2 included in the second pixel PXT2 may be controlled by the second scan signal GW2, the second switching transistor STR2 may be turned on in the first section ST1. Because an operation of the third switching transistor STR3 included in the second pixel PXT2 may be controlled by the first scan signal GW1, the third switching transistor STR3 may be also turned on in the first section ST1. Thus, as both the second switching transistor STR2 and the third switching transistor STR3 are turned on, the first data voltage DV1 received through the data line DL1 may be transmitted to the third node N3 via the second switching transistor STR2 and the third switching transistor STR3.

Referring to FIGS. 4 and 5B, the data signal D1 may have the second data voltage DV2 in the second section ST2. As in the first section ST1, the first scan signal GW1 may be in a state of entering the first level section LS1, and the second scan signal GW2 may also be in a state of entering the second level section LS2. That is, in the second section ST2, the first scan signal GW1 and the second scan signal GW2 may be a high level.

The first switching transistor STR1 included in the first pixel PXT1 may be turned on even in the second section ST2 like the first section ST1. Thus, the second data voltage DV2 may be transmitted the first node N1 via the first switching transistor STR1.

Because the operation of the second switching transistor STR2 included in the second pixel PXT2 may be controlled by the second scan signal GW2, the second switching transistor STR2 may be turned off in the second section ST2, which is different from that in the first section ST1. Thus, even when the third switching transistor STR3 is turned on by the first scan signal GW1, the second data voltage DV2 may not pass through the second switching transistor STR2 and thus may not be transmitted to the third node N3. In this case, the first data voltage DV1 received in the first section ST1 may be maintained at the third node N3.

According to an embodiment of the present disclosure, in the second section ST2, the data signal D1 transmitted through the data line DL1 may be transmitted to one of the pixels PXT1 and PXT2 connected to the data line DL1 and arranged in the same row. That is, the additional circuit for transmitting the signal to one of the pixels PXT1 and PXT2 may be omitted, and thus the signal for controlling the additional circuit may not be required. That is, as the additional circuit is omitted, power consumption of the display device DD may be reduced.

Referring to FIGS. 4 and 5C, the data signal D1 may have the fourth data voltage DV4 in the third section ST3. The first scan signal GW1 may be in a state of deviating from the first level section LS1 unlike the first section ST1 and the second section ST2, and the second scan signal GW2 may be in a state entering the second level section LS2 like the second section ST2. The third data voltage DV3 illustrated in FIG. 4 may be provided to a pixel disposed in the second row. That is, a section in which the third data voltage DV3 is provided may correspond to the first section ST1 of the pixel disposed in the first row.

Because the operation of the first switching transistor STR1 included in the first pixel PXT1 may be controlled by the first scan signal GW1, the first switching transistor STR1 may be turned off in the third section ST3 unlike the first section ST1 and the second section ST2. Thus, the fourth data voltage DV4 received through the data line DL1 may not pass through the first switching transistor STR1 and thus may not transmitted to the first node N1. In this case, the second data voltage DV2 received in the second section ST2 may be maintained at the first node N1.

The second switching transistor STR2 included in the second pixel PXT2 may be turned off even in the third section ST3 like the second section ST2. Because the operation of the third switching transistor STR3 may be controlled by the first scan signal GW1, the third switching transistor STR3 may also be turned off. Thus, the fourth data voltage DV4 received through the data line DL1 may not pass through the second switching transistor STR2 and the third switching transistor STR3 and thus may not be transmitted to the third node N3. In this case, the first data voltage DV1 received in the first section ST1 may be still maintained at the third node N3.

Referring to FIG. 4, a section in which the fifth data voltage DV5 is received may be a section in which both waveforms of the first scan signal GW1 and the second scan signal GW2 have a low level. Thus, when the third section ST3 is terminated, the first light emitting element ED1 of the first pixel PXT1 and the second light emitting element ED2 of the second pixel PXT2 may start to emit lights. However, this is merely an example, and the first light emitting element ED1 and the second light emitting element ED2 may start to emit lights from a section in which the third data voltage DV3 is received. The first light emitting element ED1 of the first pixel PXT1 and the second light emitting element ED2 of the second pixel PXT2 may emit lights corresponding to the received data voltages DV1 and DV2 according to the timing diagram of FIG. 4.

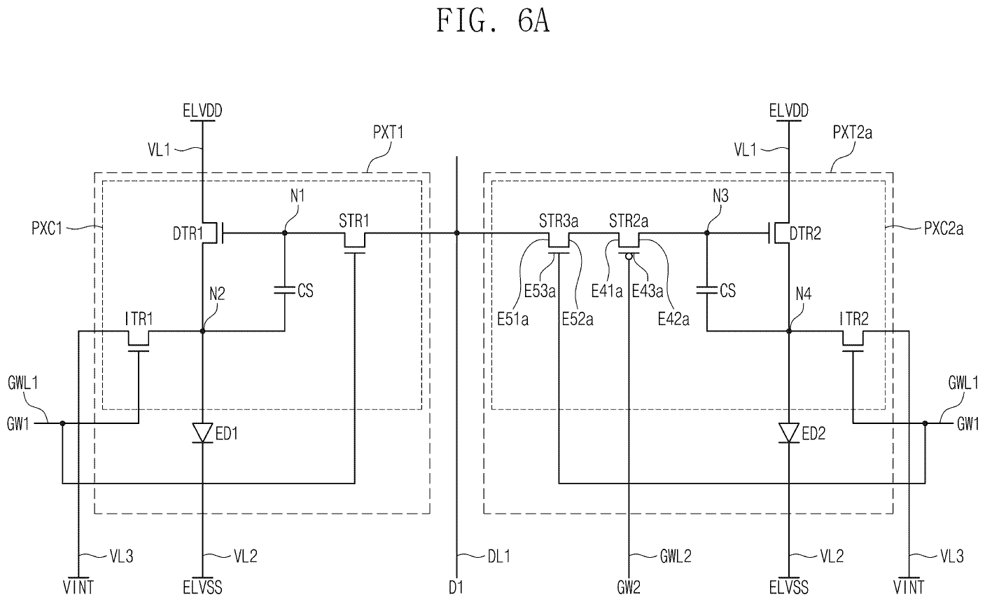

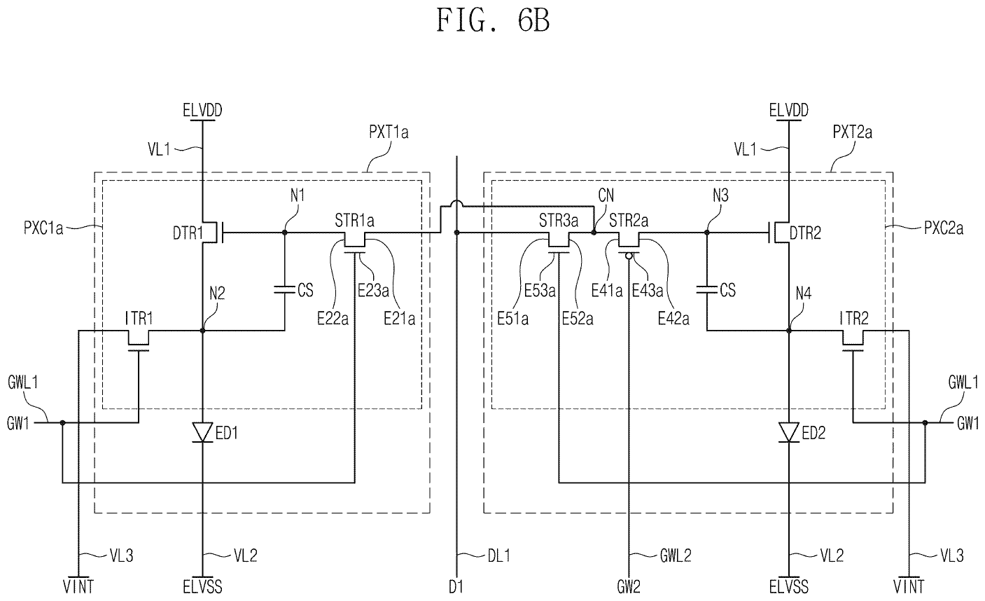

FIG. 6A is an equivalent circuit diagram of the first pixel PXT1 and a second pixel PXT2a according to an embodiment of the present disclosure. In description of FIG. 6A, the same reference numerals are designated by the same components described in FIG. 3, and a description thereof will be omitted.

Referring to FIG. 6A, the first pixel PXT1 and the second pixel PXT2a may be connected to the data line DL1. The first pixel PXT1 and the second pixel PXT2a may be pixels arranged in the same row.

The second pixel PXT2a may include a second pixel circuit PXC2a and the second light emitting element ED2. The second pixel circuit PXC2a may include the second driving transistor DTR2, a second switching transistor STR2a, a third switching transistor STR3a, the second initialization transistor ITR2, and the capacitor CS. The second pixel PXT2a may be electrically connected to the first scan line GWL1, the second scan line GWL2, and the data line DL1.

The second switching transistor STR2a includes a first electrode E41a connected to a second electrode E52a of the third switching transistor STR3a, a second electrode E42a connected to the third node N3, and a gate electrode E43a connected to the second scan line GWL2. The second switching transistor STR2a may be connected between the gate of the second driving transistor DTR2 and the third switching transistor STR3a. The gate of the second switching transistor STR2a may be connected to the second scan line GWL2, and thus an operation of the second switching transistor STR2a may be controlled by the second scan signal GW2 received through the second scan line GWL2. The second switching transistor STR2a may transmit the data signal D1 received through the data line DL1 to the third node N3 in response to the second scan signal GW2.

The third switching transistor STR3a includes a first electrode E51a connected to the data line DL1, a second electrode E52a connected to the first electrode E41a of the second switching transistor STR2a, and a gate electrode E53a connected to the first scan line GWL1. The third switching transistor STR3a may be connected between the data line DL1 and the second switching transistor STR2a. An operation of the third switching transistor STR3a may be controlled by the first scan signal GW1 received through the first scan line GWL1.

According to an embodiment of the present disclosure, the second pixel PXT2a may include the second switching transistor STR2a and the third switching transistor STR3a having different types. Thus, at least one of the second switching transistor STR2a and the third switching transistor STR3a may have a different type from that of the first switching transistor STR1. Thus, operation timings of the first switching transistor STR1, the second switching transistor STR2a, and the third switching transistor STR3a may be controlled, and thus the signals transmitted through the data line DL1 may be transmitted to the first pixel PXT1 and the second pixel PXT2a.

Referring to FIGS. 4 and 6A, the second switching transistor STR2a may be connected closer to the gate of the second driving transistor DTR2 than the third switching transistor STR3a. Referring to the timing diagram of FIG. 4, the second switching transistor STR2a is turned off earlier than the third switching transistor STR3a. Thus, a probability that the gate of the second driving transistor DTR2 is affected by charges remaining in the third switching transistor STR3a may be reduced.

FIG. 6B is an equivalent circuit diagram of a first pixel PXT1a and the second pixel PXT2a according to an embodiment of the present disclosure. In description of FIG. 6B, the same reference numerals are designated by the same components described in FIGS. 3 and 6A, and a description thereof will be omitted.

Referring to FIG. 6B, the first pixel PXT1a may include a first pixel circuit PXC1a and the first light emitting element ED1. The first pixel circuit PXC1a may include the first driving transistor DTR1, a first switching transistor STR1a, the first initialization transistor ITR1, and the capacitor CS. The first pixel PXT1a may be electrically connected to the first scan line GWL1 and the data line DL1.

The first switching transistor STR1a includes a first electrode E21a connected to a connection node CN between the second switching transistor STR2a and the third switching transistor STR3a, a second electrode E22a connected to the first node N1, and a gate electrode E23a connected to the first scan line GWL1. The first switching transistor STR1a may be electrically connected to the connection node CN between the second switching transistor STR2a and the third switching transistor STR3a, and the first switching transistor STR1a may be electrically connected to the data line DL1 through the third switching transistor STR3a.

Referring to FIG. 4 together, the first data voltage DV1 received in the first section ST1 may be transmitted to the third node N3 of the second pixel PXT2, and the second data voltage DV2 received in the second section ST2 may be transmitted to the first node N1 of the first pixel PXT1a.

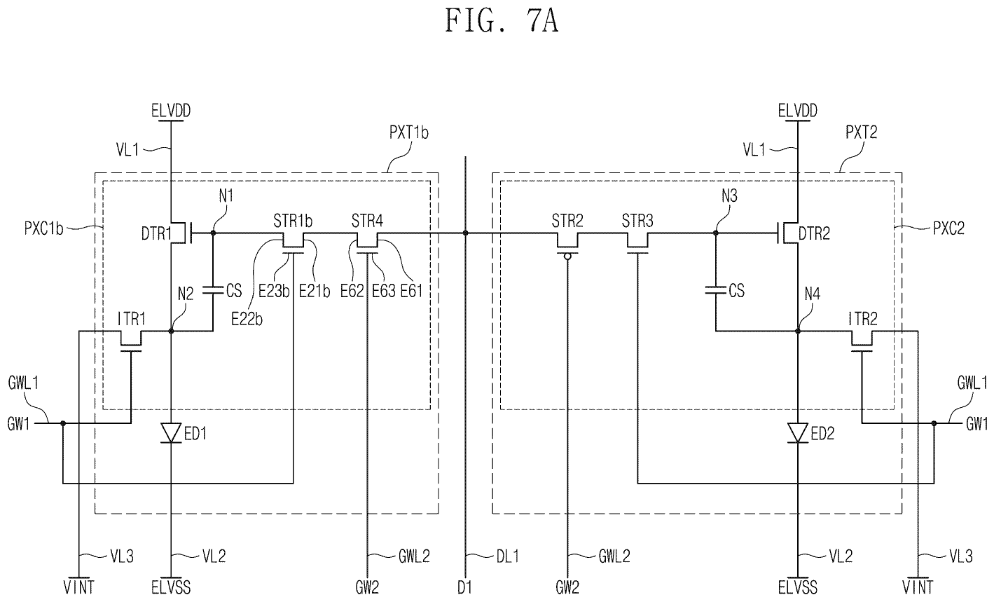

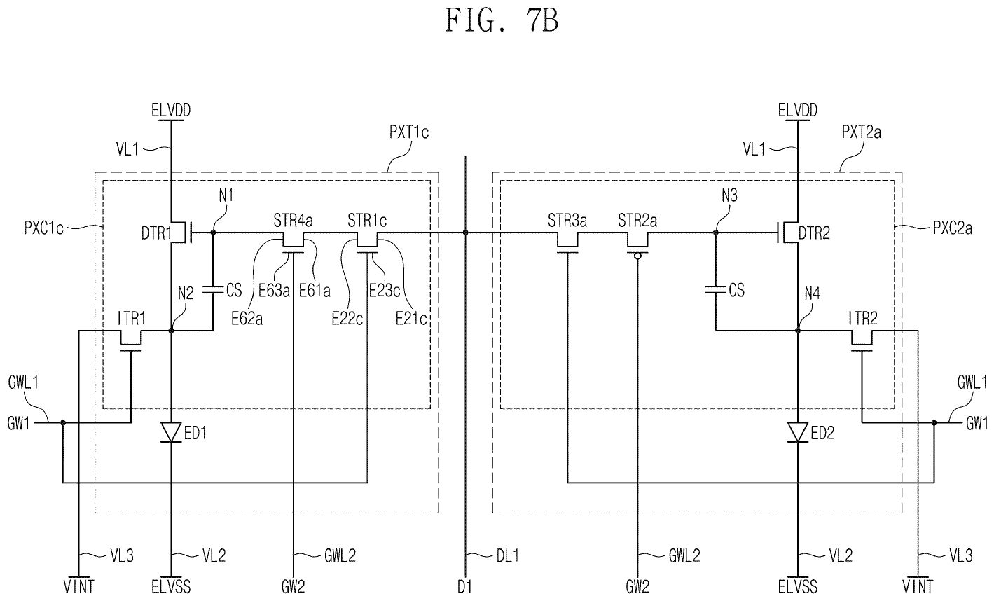

FIG. 7A is an equivalent circuit diagram of a first pixel PXT1b and the second pixel PXT2 according to an embodiment of the present disclosure. In description of FIG. 7A, the same reference numerals are designated by the same components described in FIG. 3, and a description thereof will be omitted.

Referring to FIG. 7A, the first pixel PXT1b may include a first pixel circuit PXC1b and the first light emitting element ED1. The first pixel circuit PXC1b may include the first driving transistor DTR1, a first switching transistor STR1b, a fourth switching transistor STR4, the first initialization transistor ITR1, and the capacitor CS.

The first switching transistor STR1b includes a first electrode E21b connected to a second electrode E62 of the fourth switching transistor STR4, a second electrode E22b connected to the first node N1, and a gate electrode E23b connected to the first scan line GWL1. The first switching transistor STR1b may be connected between the gate of the first driving transistor DTR1 and the second electrode E62 of the fourth switching transistor STR4.

The fourth switching transistor STR4 includes a first electrode E61 connected to the data line DL1, the second electrode E62 connected to the first switching transistor STR1b, and a gate electrode E63 connected to the second scan line GWL2. The fourth switching transistor STR4 may be connected between the data line DL1 and the first switching transistor STR1b. A gate of the fourth switching transistor STR4 may be connected to the second scan line GWL2, and an operation of the fourth switching transistor STR4 may be controlled by the second scan signal GW2.

FIG. 7B is an equivalent circuit diagram of a first pixel PXT1c and the second pixel PXT2a according to an embodiment of the present disclosure. In description of FIG. 7B, the same reference numerals are designated by the same components described in FIGS. 3 and 6A, and a description thereof will be omitted.

Referring to FIG. 7B, the first pixel PXT1c may include a first pixel circuit PXC1c and the first light emitting element ED1. The first pixel circuit PXC1c may include the first driving transistor DTR1, a first switching transistor STR1c, a fourth switching transistor STR4a, the first initialization transistor ITR1, and the capacitor CS.

The first switching transistor STR1c includes a first electrode E21c connected to the data line DL1, a second electrode E22c connected to a first electrode E61a of the fourth switching transistor STR4a, and a gate electrode E23c connected to the first scan line GWL1.

The fourth switching transistor STR4a includes the first electrode E61a connected to the second electrode E22c of the first switching transistor STR1c, a second electrode E62a connected to the first node N1, and a gate electrode E63a connected to the second scan line GWL2. The fourth switching transistor STR4a may be connected between the first switching transistor STRIc and the first node N1. A gate of the fourth switching transistor STR4a may be connected to the second scan line GWL2, and an operation of the fourth switching transistor STR4a may be controlled by the second scan signal GW2.

FIG. 7A may be an embodiment in which the fourth switching transistor STR4 is added to FIG. 3. FIG. 7B may be an embodiment in which the fourth switching transistor STR4a is added to FIG. 6A.

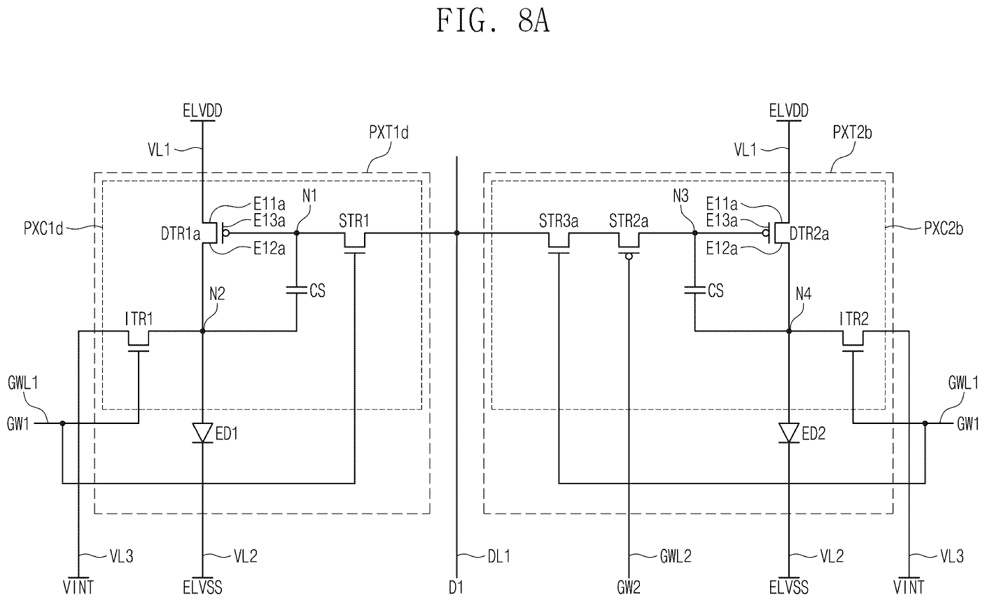

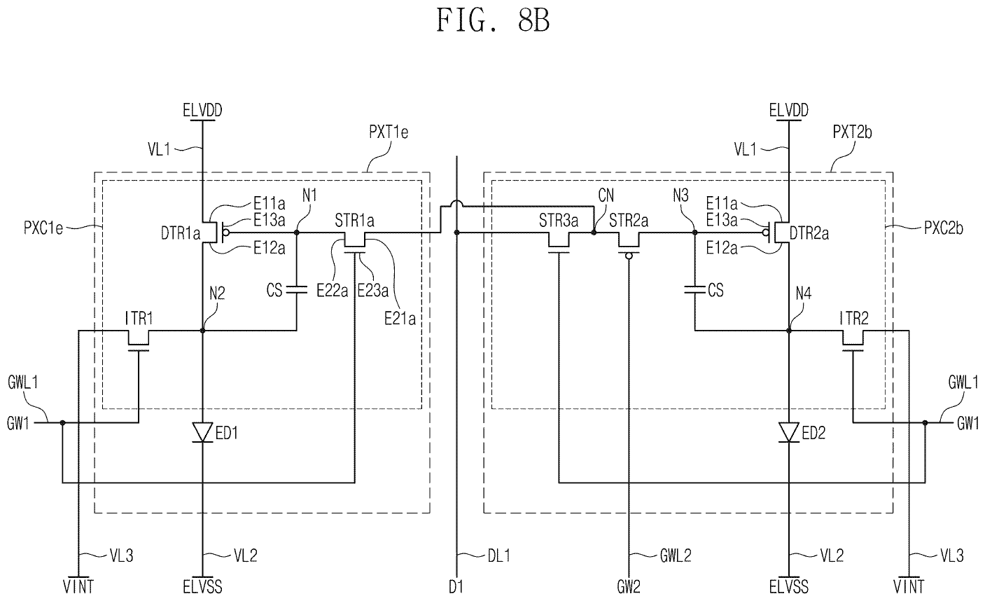

FIG. 8A is an equivalent circuit diagram of a first pixel PXT1d and a second pixel PXT2b according to an embodiment of the present disclosure. In description of FIG. 8A, the same reference numerals are designated by the same components described in FIGS. 3 and 6A, and a description thereof will be omitted.

Referring to FIG. 8A, the first pixel PXT1d may include a first pixel circuit PXC1d and the first light emitting element ED1. The first pixel circuit PXC1d may include a first driving transistor DTR1a, the first switching transistor STR1, the first initialization transistor ITR1, and the capacitor CS.

The first driving transistor DTR1a of the first pixel PXT1d may be a P-type transistor, and the first initialization transistor ITR1 thereof may be an N-type transistor. The first driving transistor DTR1a may include a first electrode E11a electrically connected to the first driving voltage line VL1, a second electrode E12a electrically connected to the anode of the first light emitting element ED1, and a gate electrode E13a.

The second pixel PXT2b may include a second pixel circuit PXC2b and the second light emitting element ED2. The second pixel circuit PXC2b may include a second driving transistor DTR2a, the second switching transistor STR2a, the third switching transistor STR3a, the second initialization transistor ITR2, and the capacitor CS.

The second driving transistor DTR2a of the second pixel PXT2b may be a P-type transistor, and the second initialization transistor ITR2 thereof may be an N-type transistor. The second driving transistor DTR2a may be substantially the same as the first driving transistor DTR1a. Thus, the second driving transistor DTR2a may also include the first electrode E11a electrically connected to the first driving voltage line VL1, the second electrode E12a electrically connected to an anode of the second light emitting element ED2, and the gate electrode E13a.

FIG. 8B is an equivalent circuit diagram of a first pixel PXT1e and the second pixel PXT2b according to an embodiment of the present disclosure. In description of FIG. 8B, the same reference numerals are designated by the same components described in FIGS. 3 and 6A, and a description thereof will be omitted.

Referring to FIG. 8B, the first pixel PXT1e may include a first pixel circuit PXC1e and the first light emitting element ED1. The first pixel circuit PXC1e may include the first driving transistor DTR1a, the first switching transistor STR1a, the first initialization transistor ITR1, and the capacitor CS.

The first driving transistor DTR1a and the second driving transistor DTR2a may be the same as those in FIG. 8A. The first switching transistor STR1a includes the first electrode E21a connected to the connection node CN between the second switching transistor STR2a and the third switching transistor STR3a, the second electrode E22a connected to the first node N1, and the gate electrode E23a connected to the first scan line GWL1. The first switching transistor STR1a may be electrically connected to the connection node CN between the second switching transistor STR2a and the third switching transistor STR3a and may be electrically connected to the data line DL1 through the third switching transistor STR3a.

FIGS. 8A and 8B illustrate that the first driving transistor DTR1a and the second driving transistor DTR2a are P-type transistors, and the first initialization transistor ITR1 and the second initialization transistor ITR2 are N-type transistors.

FIG. 8A may be an embodiment in which the first driving transistor DTR1a and the second driving transistor DTR2a in FIG. 6A are changed to P-type transistors, and FIG. 8B may be an embodiment in which the first driving transistor DTR1a and the second driving transistor DTR2a in FIG. 6B are changed to P-type transistors.

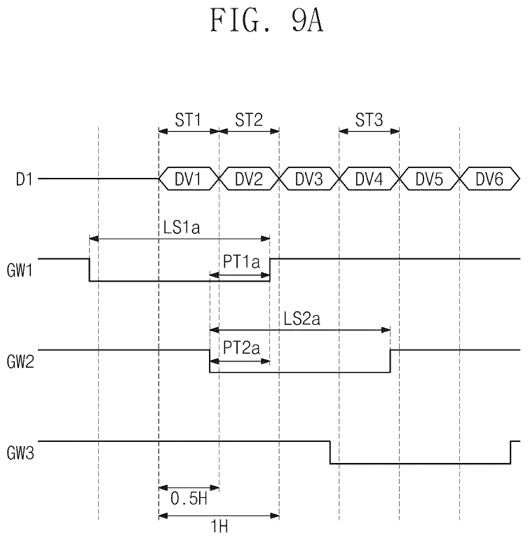

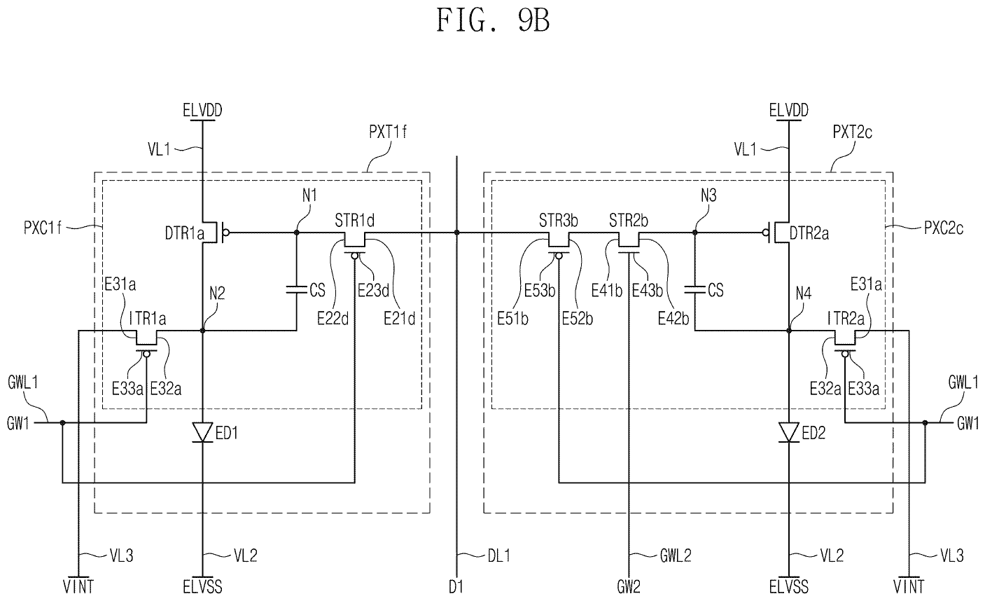

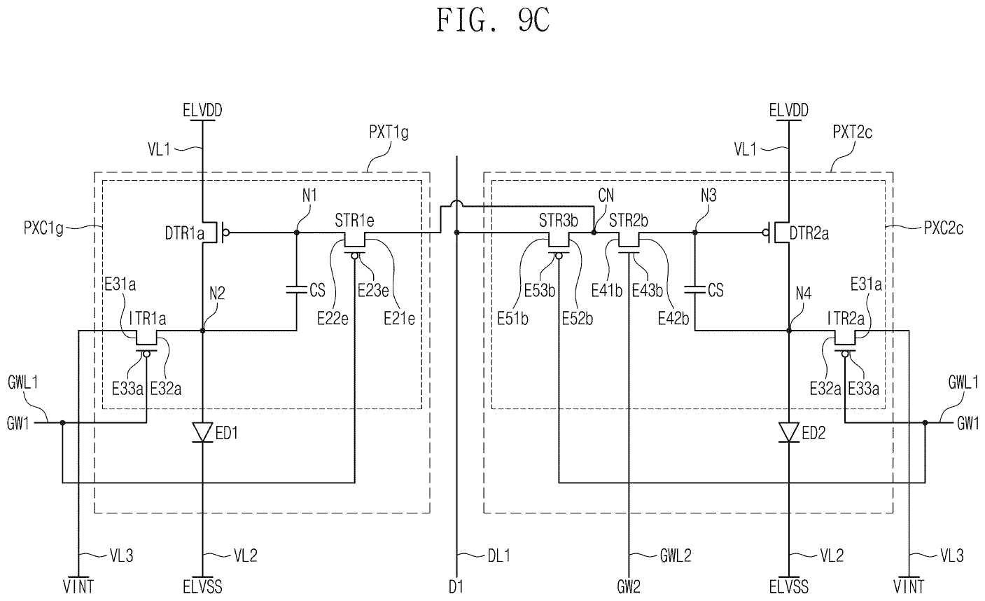

FIG. 9A is a timing diagram for describing operations of first pixels PXT1f and PXT1g and a second pixel PXT2c according to an embodiment of the present disclosure.

FIG. 9A is a timing diagram applied to circuit diagrams of FIGS. 9B and 9C. Referring to FIG. 9A, each of the first section ST1, the second section ST2, and the third section ST3 may correspond to a 0.5 horizontal period 0.5 H. That is, a length of one section may be 0.5 horizontal period 0.5 H, and a length of two sections may be 1 horizontal period 1 H.

According to an embodiment of the present disclosure, the data signal D1 may have the different data voltages DV1, DV2, DV3, DV4, DV5, and DV6 for each 0.5 horizontal period. For example, the data signal D1 may have the first data voltage DV1 in the first section ST1 and the second data voltage DV2 in the second section ST2.

Referring to FIGS. 9B and 9C together, the first scan signal GW1 received through the first scan line GWL1 may have a first level section LS1a that is a low level section. The second scan signal GW2 received through the second scan line GWL2 may have a second level section LS2a that is a low level section. A length of the first level section LS1a and a length of the second level section LS2a may be greater than or equal to 1.5 horizontal periods and less than 2 horizontal periods.

In an embodiment of the present disclosure, the waveform of the first scan signal GW1 and the waveform of the second scan signal GW2 may be different from each other. In this case, the waveform of the first scan signal GW1 and the waveform of the second scan signal GW2 may overlap each other at a first part PT1a of the first level section LS1a and a second part PT2a of the second level section LS2a. A length of the overlapping first part PT1a and a length of the overlapping second part PT2a may be greater than or equal to 0.5 horizontal period and less than 1 horizontal period.

FIG. 9B is an equivalent circuit diagram of the first pixel PXT1f and the second pixel PXT2c according to an embodiment of the present disclosure. In description of FIG. 9B, the same reference numerals are designated by the same components described in FIGS. 3 and 6A, and a description thereof will be omitted.

Referring to FIG. 9B, the first pixel PXT1f may include a first pixel circuit PXC1f and the first light emitting element ED1. The first pixel circuit PXC1f may include the first driving transistor DTR1a, a first switching transistor STR1d, a first initialization transistor ITR1a, and the capacitor CS. The first pixel PXT1f may be electrically connected to the first scan line GWL1 and the data line DL1.

A first switching transistor STR1d includes a first electrode E21d connected to the data line DL1, a second electrode E22d connected to the first node N1, and a gate electrode E23d connected to the first scan line GWL1. The first switching transistor STR1d may be connected between a gate of the first driving transistor DTR1a and the data line DL1. A gate of the first switching transistor STR1d may be connected to the first scan line GWL1, and an operation of the first switching transistor STR1d may be controlled by the first scan signal GW1 received through the first scan line GWL1.

The first initialization transistor ITR1a includes a first electrode E31a connected to the third driving voltage line VL3, a second electrode E32a connected to the second node N2, and a gate electrode E33a connected to the scan line GWL1. The first initialization transistor ITR1a may be connected to the first light emitting element ED1, and a gate of the first initialization transistor ITR1a may be connected by the first scan line GWL1. An operation of the first initialization transistor ITR1 may be controlled by the first scan signal GW1 received through the first scan line GWL1.

The second pixel PXT2c may include a second pixel circuit PXC2c and the second light emitting element ED2. The second pixel circuit PXC2c may include the second driving transistor DTR2a, a second switching transistor STR2b, a third switching transistor STR3b, a second initialization transistor ITR2a, and the capacitor CS. The second pixel PXT2c may be electrically connected to the first scan line GWL1, the second scan line GWL2, and the data line DL1.

A structure of the second initialization transistor ITR2a may be substantially the same as a structure of the first initialization transistor ITR1a of the first pixel PXT1f.

The second switching transistor STR2b includes a first electrode E41b connected to a second electrode E52b of the third switching transistor STR3b, a second electrode E42b connected to the third node N3, and a gate electrode E43b connected to the second scan line GWL2. The second switching transistor STR2b may be connected between the gate of the second driving transistor DTR2a and the third switching transistor STR3b. The gate of the second switching transistor STR2b may be connected to the second scan line GWL2, and thus an operation of the second switching transistor STR2b may be controlled by the second scan signal GW2 received through the second scan line GWL2.

The third switching transistor STR3b includes a first electrode E51b connected to the data line DL1, a second electrode E52b connected to the first electrode E41b of the second switching transistor STR2b, and a gate electrode E53b connected to the first scan line GWL1. The third switching transistor STR3b may be connected between the data line DL1 and the second switching transistor STR2b. An operation of the third switching transistor STR3b may be controlled by the first scan signal GW1 received through the first scan line GWL1.

Referring to FIGS. 9A and 9B together, in the first section ST1, all the first switching transistor STR1d, the second switching transistor STR2b, and the third switching transistor STR3b are turned on, and thus the first data voltage DV1 received in the first section ST1 may be transmitted to the first node N1 of the first pixel PXT1f and the third node N3 of the second pixel PXT2c. In the second section ST2, the first switching transistor STR1d and the third switching transistor STR3b are turned on, but the second switching transistor STR2b is turned off. Thus, the second data voltage DV2 received in the second section ST2 may be transmitted only to the first node N1 of the first pixel PXT1f.

FIG. 9C is an equivalent circuit diagram of the first pixel PXT1g and the second pixel PXT2c according to an embodiment of the present disclosure. In description of FIG. 9C, the same reference numerals are designated by the same components described in FIGS. 3 and 6A, and a description thereof will be omitted.

Referring to FIG. 9C, the first pixel PXT1g may include a first pixel circuit PXC1g and the first light emitting element ED1. The first pixel circuit PXC1g may include the first driving transistor DTR1a,a first switching transistor STR1e, the first initialization transistor ITR1a, and the capacitor CS. The first pixel PXT1g may be electrically connected to the first scan line GWL1 and the data line DL1.

The first switching transistor STR1e includes a first electrode E21e connected to the connection node CN between the second switching transistor STR2b and the third switching transistor STR3b, a second electrode E22e connected to the first node N1, and a gate electrode E23e connected to the first scan line GWL1. The first switching transistor STR le may be electrically connected to the connection node CN between the second switching transistor STR2b and the third switching transistor STR3b and may be electrically connected to the data line DL1 through the third switching transistor STR3b.

Referring to FIGS. 9A and 9C together, as illustrated in FIG. 9B, the first data voltage DV1 received in the first section ST1 may be transmitted to the first node N1 of the first pixel PXT1f and the third node N3 of the second pixel PXT2c, and the second data voltage DV2 received in the second section ST2 may be transmitted only to the first node N1 of the first pixel PXT1g.

FIGS. 9B and 9C may be an embodiment in which all the first driving transistor DTR1a, the second driving transistor DTR2a, the first initialization transistor ITR1a, and the second initialization transistor ITR2a are P-type transistors, and the second switching transistor STR2b is an N-type transistor.

FIG. 9B may be an embodiment in which the first initialization transistor ITR1a, the second initialization transistor ITR2a, the first switching transistor STR1d, and the third switching transistor STR3b are changed to P-type transistors, and the second switching transistor STR2b is changed to an N-type transistor in FIG. 8A.

FIG. 9C may be an embodiment in which the first switching transistor STR1e is changed to be connected to the connection node CN between the second switching transistor STR2b and the third switching transistor STR3b in FIG. 9B.

In a display device according to an embodiment of the present disclosure, as the number of data lines is reduced, power consumption due to output of data voltages to the data lines may be reduced. Further, as the number of output terminals of a data driver is reduced, manufacturing costs of the data driver may be reduced. Even when a difference in luminance occurs between a first pixel and a second pixel due to a difference of a circuit configuration, the difference in luminance may not be visually recognized. Thus, display quality of a display device may be improved.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. A display device comprising:
a first scan line configured to receive a first scan signal;
a second scan line configured to receive a second scan signal;
a data line configured to receive a first data voltage and a second data voltage;
a first pixel electrically connected to the first scan line and the data line; and
a second pixel electrically connected to the first scan line, the second scan line, and the data line,
wherein the first pixel includes a first light emitting element, a first driving transistor connected to the first light emitting element, and a first switching transistor connected between a gate of the first driving transistor and the data line,
wherein the second pixel includes a second light emitting element, a second driving transistor connected to the second light emitting element, and a second switching transistor connected between a gate of the second driving transistor and the data line, and
wherein one of the first switching transistor and the second switching transistor is an N-type transistor, and the other one thereof is a P-type transistor.

2. The display device of claim 1, wherein a gate of the first switching transistor is connected to the first scan line, and an operation of the first switching transistor is controlled by the first scan signal, and
wherein a gate of the second switching transistor is connected to the second scan line, and an operation of the second switching transistor is controlled by the second scan signal.

3. The display device of claim 2, wherein the second pixel further includes a third switching transistor connected between the gate of the second driving transistor and the second switching transistor, and
wherein a gate of the third switching transistor is connected to the first scan line, and an operation of the third switching transistor is controlled by the first scan signal.

4. The display device of claim 3, wherein the first switching transistor is an N-type transistor, the second switching transistor is a P-type transistor, and the third switching transistor is an N-type transistor.

5. The display device of claim 3, wherein the first pixel further includes a fourth switching transistor connected between the data line and the first switching transistor, and
wherein a gate of the fourth switching transistor is connected to the second scan line, and an operation of the fourth switching transistor is controlled by the second scan signal.

6. The display device of claim 2, wherein the second pixel further includes a third switching transistor connected between the second switching transistor and the data line, and
wherein a gate of the third switching transistor is connected to the first scan line, and an operation of the third switching transistor is controlled by the first scan signal.

7. The display device of claim 6, wherein the first switching transistor is electrically connected to a connection node between the second switching transistor and the third switching transistor, and the first switching transistor is electrically connected to the data line through the third switching transistor.

8. The display device of claim 6, wherein the first pixel further includes a fourth switching transistor connected between the first switching transistor and a first node, and
wherein a gate of the fourth switching transistor is connected to the second scan line, and an operation of the fourth switching transistor is controlled by the second scan signal.

9. The display device of claim 1, wherein the first pixel further includes a first initialization transistor connected to the first light emitting element, and the second pixel further includes a second initialization transistor connected to the second light emitting element, and
wherein gates of the first initialization transistor and the second initialization transistor are connected to the first scan line, and operations of the first initialization transistor and the second initialization transistor are controlled by the first scan signal.

10. The display device of claim 9, wherein the first driving transistor, the second driving transistor, the first initialization transistor, and the second initialization transistor are N-type transistors.

11. The display device of claim 9, wherein the first driving transistor and the second driving transistor are P-type transistors, and the first initialization transistor and the second initialization transistor are N-type transistors.

12. The display device of claim 9, wherein the first driving transistor, the second driving transistor, the first initialization transistor, and the second initialization transistor are P-type transistors.

13. The display device of claim 1, wherein a first part of the first scan signal in a first level section overlaps a second part of the second scan signal in a second level section.

14. The display device of claim 13, wherein a length of each of the first level section and the second level section is greater than or equal to 1.5 horizontal periods and less than 2 horizontal periods, and
wherein a length of each of the first part and the second part is greater than or equal to 0.5 horizontal periods and less than 1 horizontal period.

15. An electronic device includes a display device for displaying an image, the display device comprising:
a first pixel including a first driving transistor and a first switching transistor;
a second pixel including a second driving transistor and a second switching transistor;
a first scan line configured to receive a first scan signal;
a second scan line configured to receive a second scan signal; and
a data line electrically connected to the first pixel and the second pixel,
wherein a gate of the first switching transistor is connected to the first scan line, and an operation of the first switching transistor is controlled by the first scan signal,
wherein a gate of the second switching transistor is connected to the second scan line, and an operation of the second switching transistor is controlled by the second scan signal, and
wherein one of the first switching transistor and the second switching transistor is an N-type transistor, and the other one thereof is a P-type transistor.

16. The electronic device of claim 15, wherein the second pixel further includes a third switching transistor connected between a gate of the second driving transistor and the second switching transistor, and
wherein a gate of the third switching transistor is connected to the first scan line, and an operation of the third switching transistor is controlled by the first scan signal.

17. The electronic device of claim 16, wherein the first pixel further includes a fourth switching transistor connected between the data line and the first switching transistor, and
wherein a gate of the fourth switching transistor is connected to the second scan line, and an operation of the fourth switching transistor is controlled by the second scan signal.

18. The electronic device of claim 15, wherein the second pixel further includes a third switching transistor connected between the second switching transistor and the data line, and
wherein a gate of the third switching transistor is connected to the first scan line, and an operation of the third switching transistor is controlled by the first scan signal.

19. The electronic device of claim 18, wherein the first switching transistor is electrically connected to a connection node between the second switching transistor and the third switching transistor, and the first switching transistor is electrically connected to the data line through the third switching transistor.

20. The electronic device of claim 15, wherein a first part of the first scan signal in a first level section overlaps a second part of the second scan signal in a second level section.
